(19) United States
(12) Patent Application Publication
(10) Pub. No.: US 2005/0190135 A1
(43) Pub. Date: Sep. 1, 2005

(54) Color correction circuit and method for liquid crystal display

(75) Inventors: Yi-Fan Chen, Taichung (TW); Yih-Liang Lu, Hsinchu (TW)

Correspondence Address: DENNISON, SCHULTZ & DOUGHERTY, 612 CRYSTAL SQUARE 4, 1745 JEFFERSON DAVIS HIGHWAY, ARLINGTON, VA, 22202, US

(73) Assignee: VastView Technology Inc.

(21) Appl. No.: 10/786,088

(22) Filed: Feb. 26, 2004

(51) Int. Cl. G09G 3/36

(52) U.S. Cl. 345/88

(57) ABSTRACT

A color correction circuit and a color correction method for a liquid crystal display, the circuit comprises a color selection unit, a parameter register unit, a color signal function calculation unit and a color signal output unit. The method is characterized in providing selection items of measuring values of color temperature values and Gamma values and providing a correction parameter value obtained by function calculation, being in corresponding to a selected selection item. A user can correct a color signal according to the color correction circuit and the method. This is applicable to color signal adjustment for liquid crystal panels.

### BACKGROUND OF THE INVENTION

1. Field of the Invention

The present invention is related to a color correction circuit and the method for a liquid crystal display (LCD), and especially to correction of color signals inputting into liquid crystal panels through function calculation, the color correction circuit and the method are applicable to liquid crystal display LCD.

2. Description of the Prior Art

Earlier screens mostly are cathode-ray tube (CRT) displays; by the principle of displaying and shaping of CRT, the displays always are huge and heavy, and make users feel oppressed and inconvenient. Thereby, some people improved the cathode-ray tubes to reduce their lengths for reducing the volumes of screens, the effect resulted was quite limited and could not totally get rid of the problem of having overly large screens. Until LCD was developed, the dream of having a light and thin screen could then be realized.

A liquid crystal display takes advantage of photoelectric effect of liquid crystals to get an object of image development through external voltage controlling, and by the characteristic of refraction and the ability of rotation to light beams of liquid crystal molecules that can get the result of brightness and darkness (or called as optic contrast), and thereby a light and thin display can be obtained. By virtue that a liquid crystal display uses a plain glass panel, the displaying effect of it in the mode of a plain surface and right angles is much better than that of a conventional screen with cambered surface. Thereby the LCD can avoid the situation that a CRT screen may have i.e. shaking and twinkling of scanning lines problem to induce visual fatigue. And more, the color presentation of the LCD can be clearer in layers distinguishing layers and more brilliant, and abundant and higher contrastable.

However, such a LCD has defects in use. The LCD is composed of liquid crystal panels; different liquid crystal panels have different characteristics of color presentation. Even in putting same color signals, different liquid crystal panels will present different colors for the panels having different colority, brightness and brilliancy. That is to say, for different liquid crystal panels to present the consistent colors when receiving same color signals, a color correction device is a necessary key device.

Some people use waveform diagrams of color signals as a reference for color correction and comparison, a kind of circuit designs of them is shown in FIG. 3 including a color-signal waveform comparison and correction unit LUT and a color-signal output unit D&FRC. The color-signal waveform comparison and correction unit LUT stores a color-correction waveform diagram. The color-correction waveform diagram is related to the corresponding relationship of the color signals with color temperature values (CT) and with Gamma values. When the color signals are inputted into the color-signal waveform comparison and correction unit LUT, the latter by using the color-correction waveform diagram compares and corrects the color temperature values (CT) and the Gamma values to obtain color signals after correction. The color signals after correction are processed by the color-signal output unit D&FRC, and then are outputted as color signals for being received and presented by liquid crystal panels.

This method can get corrected color signals to render the display having better color presentation; however, such method adopts waveforms of color signals for comparison and correction, a large amount of data of color waveform diagrams must be stored in use. They must occupy an extremely large memory space, and such mode of color correction always can only make color correction according to a single item of color-correction waveform diagram. Yet fondness of color is kind of subjective feeling. Different users always have different fondness and requirements; such method of color correction according to a single item of color-correction waveform diagram cannot satisfy the requirements of users in color selection.

In view of the above stated conventional defects, for providing a novel measure of color correction for a LCD, the inventors provide the present invention according to academic research and designing as well as improvement in experiments.

### SUMMARY OF THE INVENTION

The primary object of the present invention is to provide a color correction circuit and a color correction method for correcting color signals on liquid crystal panels through function calculation, and the color correction circuit and the method are applicable to LCD.

In order to achieve the above object, the present invention includes a color selection unit, a parameter register unit, a color signal function-calculation unit and a color signal output unit. The color selection unit provides selection items of CT values and Gamma values, and provides a correction parameter value in corresponding to the selected item of CT values and Gamma values. The correction parameter values are loaded into the parameter register unit. The color signal function-calculation unit receives an inputted color signal to make an calculation of color signal correction according to the correction parameter values and to output a color signal calculated value; then the color signal output unit receives and processes the color signal calculated value to output a color signal.

The present invention will be more apparent after reading the detailed description of the preferred embodiment thereof in reference to the accompanying drawings.

### BRIEF DESCRIPTION OF THE DRAWINGS

FIG. 1 is a circuit arrangement diagram of an embodiment of the present invention;

FIG. 2 is the structure diagram of the color signal function-calculation unit;

FIG. 3 is a curve figure of initial Gamma values of red, blue and green signals respectively;

FIG. 4 is a curve figure of normalized Gamma values of red, blue and green signals respectively;

FIG. 5 is a curve figure of corrected Gamma values of red, blue and green signals respectively;

FIG. 6 is a system arrangement diagram of a prior art.

### DETAILED DESCRIPTION OF THE PREFERRED EMBODIMENT

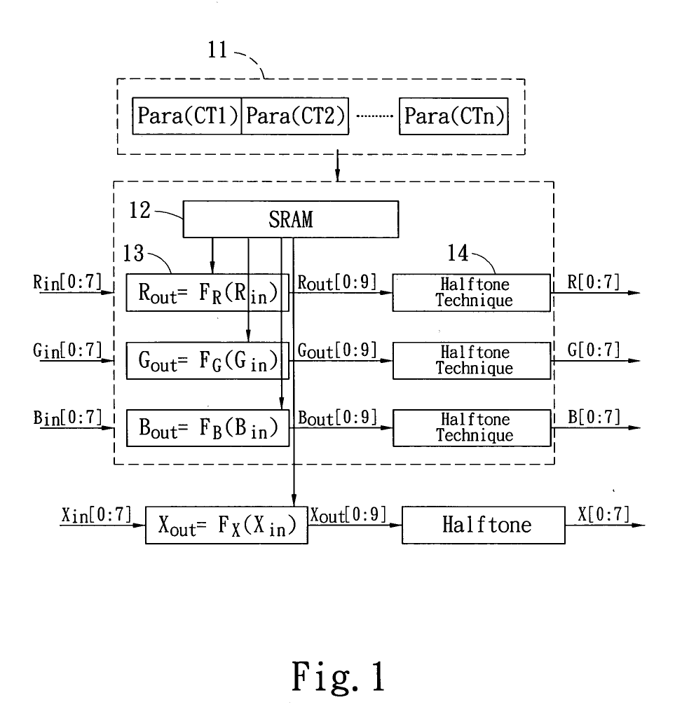

Referring firstly to FIG. 1 showing electric circuit arrangement of an embodiment of the present invention, the circuit comprises a color selection unit 11, a parameter register unit 12, a color signal function-calculation unit 13 and a color signal output unit 14; it is used for correction of red, blue and green input signals. The color selection unit 11 is stored in an ROM (Read-Only-Memory) and it includes the contents of selection items Para (CT1), Para (CT2) till Para (CTn) of a plurality of items of CT values and Gamma values, the measuring values of the CT values and Gamma values of liquid crystal panels, and the correction parameter values obtained by function calculation being in corresponding to the selection items and measuring values of the selected CT values (CT) and Gamma values.

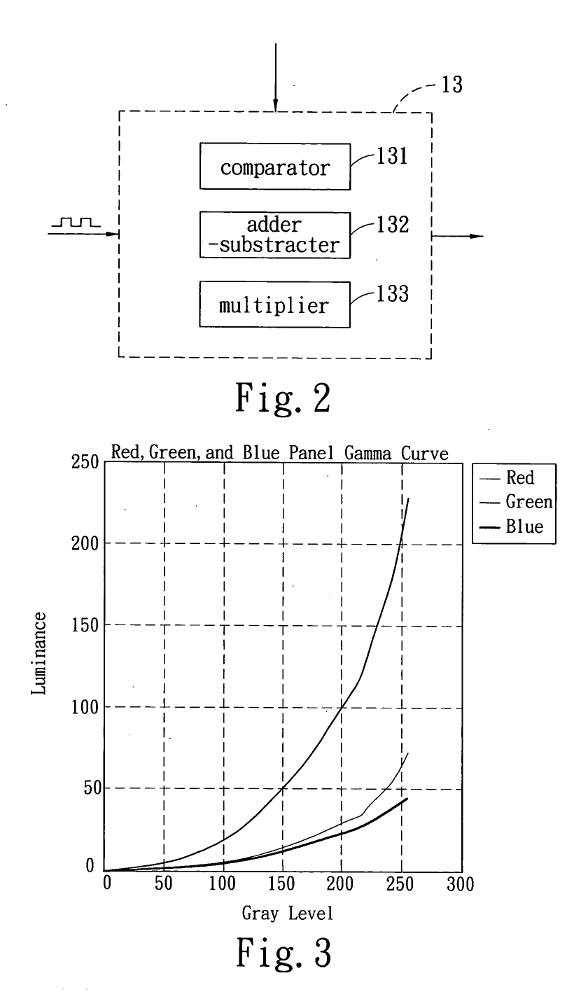

The parameter register unit 12 is an SRAM (Static Random Access Memory). A user can use it to temporarily load and store correction parameter values obtained by the selected item(s) of CT values and Gamma values. Referring to FIG. 2, the color signal function-calculation unit 13 includes a comparator 131, an adder-substracter 132 and a multiplier 133. It can read the correction parameter values from the parameter register unit 12 to respectively calculate the color signals Rin, Bin and Gin of red, blue, and green colors, which are inputted into the color signal function-calculation unit 13, and to respectively output the color signal calculated values Rout, Bout and Gout of red, blue, and green colors. The color signal output unit 14 uses a halftone technique to process the color signal calculation values Rout, Bout and Gout respectively outputted from the color signal function-calculation unit 13 and obtains color signals of red, blue and green colors suitable for presenting on a LCD.

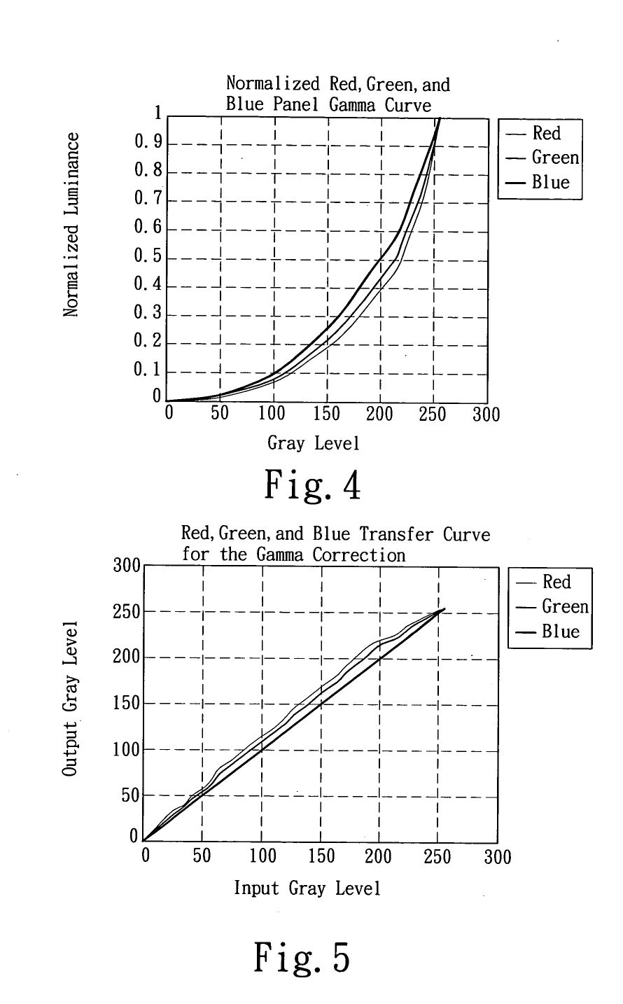

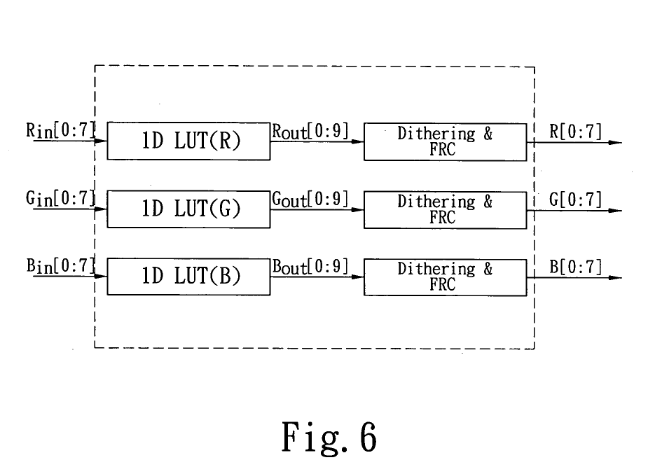

The embodiment of the present invention corrects color signals of red, blue and green colors for liquid crystal panels by function calculation. The curves of the initial measuring values of Gamma respectively of red, blue and green signals of the liquid crystal panels are shown in FIG. 3. The color signals of red, blue and green colors respectively present parabolic curves of different curvatures are processed by normalization to make consistence of the curves of the red, blue and green signals, such as shown in FIG. 4. The red, blue and green signals of the present invention and the selection items of the CT values and Gamma values selected by the user are respectively the variations X₁ and X₂, i.e.
Y=F₁(X₁)=F₂(X₂)

The correction function of the embodiment of the present invention is:
F₂(X₂)=C X₂^{γ}

After the above correction function and calculating by the following formula:
→X₂=Function (X₁)
a corrected curve is obtained as shown in FIG. 5.

The corrected curve is divided into 1 to n sections, and then correction parameters a_{R}_{₁₋ₙ}, b_{R}_{₁₋ₙ}, a_{B}_{₁₋ₙ}, b_{B}_{₁₋ₙ}, a_{G}_{₁₋ₙ}, b_{G}_{₁₋ₙ} of all the sections of the corrected curve are obtained, and the correction parameters a_{R}_{₁₋ₙ}, b_{R}_{₁₋ₙ}, a_{B}_{₁₋ₙ}, b_{B}_{₁₋ₙ}, a_{G}_{₁₋ₙ}, b_{G}_{₁₋ₙ} are used to calculate to obtain the color signal calculated values Rout, Bout and Gout respectively of the red, blue and green colors.
Rout₁₋ₙ=a_{R}_{₁₋ₙ}Rin+b_{R}_{₁₋ₙ},
Bout₁₋ₙ=a_{B}_{₁₋ₙ}Bin+b_{B}_{₁₋ₙ},
Gout₁₋ₙ=a_{G}_{₁₋ₙ}Gin+b_{G}_{₁₋ₙ},

The processing steps of the embodiment of the present invention are:

Step 1: a user selects one of the selection items Para (CT1), Para (CT2) till Para (CTn) of a plurality of items of CT value item and Gamma values to obtain correction parameters a and b obtained by function calculation being in corresponding to the selection items of measuring values of the CT values and Gamma values of liquid crystal panels.

Step 2: the parameter register unit 12 temporarily loads the correction parameter values a and b obtained by the selected selection items of the CT values and Gamma values.

Step 3: the correction parameter values loaded in the parameter register unit 12 are used and the color signals Rin, Bin and Gin of red, blue and green colors are respectively input to the color signal function-calculation unit 13, through the comparator 131, the adder-substracter 132 and the multiplier 133 of the color signal function-calculation unit 13 for calculating to respectively output the color signal calculated values Rout, Bout and Gout of the red, blue and green colors.

Step 4: the color signal output unit 14 respectively receives and processes the color signal calculated values Rout, Bout and Gout respectively of the red, blue and green colors output from the color signal function-calculation unit 13 and outputs color signals of red, blue and green colors.

Therefore, the present invention has the following advantages:
1. Saving the resource of hardware: need of storing space of a color correction function is much less than that for waveform diagrams of color signals, thereby the resource of hardware can be saved.
2. Having a variety of color selection items: it provides a plurality of items of color selection items (CT values and Gamma values) for users selecting, correcting and adjusting colors according to one's own fondness, so that the user can have favorite colors on his LCD.

In conclusion, according to the description disclosed above, the present invention surely can achieve the expected object thereof to do correction of color signals in to liquid crystal panels through a function calculation; the present invention is suitable for LCD, it has a high industrial value. Therefore, what we claim as new and desire to be secured by Letters Patent of the United States are:

1. A color correction circuit for a liquid crystal display comprises:
a color selection unit providing selection items of color temperature values (CT) and Gamma values (ratio of brightness to gray scale) and providing a correction parameter value in corresponding to said CT values and Gamma values selected;
a parameter register unit to load said correction parameter value;
a color signal function-calculation unit to receive an input color signal to make an calculation of color signal correction according to said correction parameter value and to output a color signal calculated-value; and
a color signal output unit receiving and processing said color signal calculated value to output a color signal.

2. The color correction circuit for a liquid crystal display as in claim 1, wherein said color selection unit is stored in an ROM (Read-Only-Memory).

3. The color correction circuit for a liquid crystal display as in claim 1, wherein said parameter register unit is an SRAM (Static Random Access Memory).

4. The color correction circuit for a liquid crystal display as in claim 1, wherein said color signal function-calculation unit includes at least a comparator, at least an adder-substracter and at least a multiplier.

5. The color correction circuit for a liquid crystal display as in claim 1, wherein said color signal output unit uses a halftone technique for processing.

6. The color correction circuit for a liquid crystal display as in claim 1, wherein said color signals are of a red channel, a blue channel and a green channel.

7. A color correction method for a liquid crystal display, said method applies a color correction circuit including a color selection unit, a parameter register unit, a color signal function-calculation unit and a color signal output unit, said method includes the steps of:
a. said color selection unit provides selection items of CT values and Gamma values;
b. after selecting an item of said selection items of CT values and Gamma values (ratio of brightness to gray scale) provided by said color selection unit, by function calculating to provide a correction parameter value in corresponding to selected CT values and Gamma values and measured CT values and Gamma values of liquid crystal panels;
c. said parameter register unit loads said correction parameter value;
d. said color signal function-calculation unit receives an input color signal to make an calculation of color signal correction according to said correction parameter value and to output a color signal calculated-value; and
e. said color signal output unit receives and processes said color signal calculated-value to output a color signal after processing.

8. The color correction method for a liquid crystal display as in claim 7, wherein said color selection unit is stored in an ROM (Read-Only-Memory).

9. The color correction method for a liquid crystal display as in claim 7, wherein said parameter register unit is an SRAM (Static Random Access Memory).

10. The color correction method for a liquid crystal display as in claim 7, wherein said color signal function-calculation unit includes at least a comparator, at least an adder-substracter and at least a multiplier.

11. The color correction method for a liquid crystal display as in claim 7, wherein said color signal output unit uses a halftone technique for processing.

12. The color correction method for a liquid crystal display as in claim 7, wherein said color signals are of a red channel, a blue channel and a green channel.
